(19) United States
(12) Patent Application Publication
(10) Pub. No.: US 2007/0121325 A1
(43) Pub. Date: May 31, 2007

(54) Light directing louver

(76) Inventor: Benjamin Barber, Needham, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/290,627

(22) Filed: Nov. 30, 2005

(51) Int. Cl. F21V 11/02

(52) U.S. Cl. 362/290

(57) ABSTRACT

A lighting system component includes a transmissive substrate having a top and bottom surface and at least one elongate passage defined between the top and bottom surfaces by walls joining the top and bottom surfaces; and a coating on the walls substantially preventing light transmission through the walls; whereby light is transmitted through the lighting system component both through the substrate and through the elongate passage substantially without passing through the walls defining the elongate passage. Some variations are possible. For example, the coating may be opaque or reflective. Plural elongate passages may form a radial pattern relative to a point on one of the top and bottom surfaces. Plural elongate passages may form a concentric pattern relative to a point on one of the top and bottom surfaces. The walls may be angled parallel to a desired directed of light transmission. At least one of the walls may define at least part of a frustum of a cone.

### BACKGROUND OF INVENTION

Modem architectural lighting often includes one or more sophisticated elements to control the behavior of the light produced by a given fixture or lamp. The structures used include reflectors, lenses, louvers and various kinds of shields, to refine and direct the beam.

Among the more popular beam control devices are various kinds of louvers, baffles, snoots or barn doors.

Large, square cell louvers are common in office lighting environments, but their ability to shield and direct a light beam is limited because they have large open spaces between each light shielding/directing element. Radial and cross hair louvers provide better results in some installations because they have more closely spaced light shielding and light directing elements, but they still may provide only limited shielding angles.

Tube baffles or snoots attach to the front of a lighting luminaire and provide very tight shielding. However, they extend in front of the luminaire, occupying space in front of the luminaire in a manner that may be undesirable. They may be considered unattractive for some applications.

Barn doors are large, flap-like appendages attached to the front of a luminaire, which allow precise adjustments to the shielding they provide. Barn doors, however, are large, and generally considered unattractive, evoking a theatrical or industrial motif.

Lenses and reflectors can also shield or diffuse a light beam to render its application more suitable to a particular architectural setting. Lenses, however, are inefficient light directors which produce bright glare and make more difficult the heat dissipation of generated heat in the luminaire. Being solid elements placed in front of a light source, lenses tend to trap heat within the luminaire. Reflectors and lamp shields can provide better beam pattern control, together with lowered glare, but there is a tradeoff with respect to efficiency.

### SUMMARY OF INVENTION

What is desired is therefore an improved light shield that can readily be made in a variety of shapes, forms and patterns, and that overcomes one or more of the deficiencies of conventional light control structures.

According to one embodiment of aspects of the invention, a lighting system component includes a transmissive substrate having a top and bottom surface and at least one elongate passage defined between the top and bottom surfaces by walls joining the top and bottom surfaces; and a coating on the walls substantially preventing light transmission through the walls; whereby light is transmitted through the lighting system component both through the substrate and through the elongate passage substantially without passing through the walls defining the elongate passage. Some variations are possible. For example, the coating may be opaque or reflective. According to another aspect, plural elongate passages may form a radial pattern relative to a point on one of the top and bottom surfaces. In an alternative aspect, plural elongate passages may form a concentric pattern relative to a point on one of the top and bottom surfaces. In connection with this alternative aspect, the walls may be angled parallel to a desired directed of light transmission. According to a more specific aspect, at least one of the walls defines at least part of a frustum of a cone.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a plan view of a first embodiment of aspects of the invention;

FIG. 1B is a cross-sectional view of the embodiment of FIG. 1A, taken through the line A-A;

FIG. IC is a detail view of the embodiment of FIGS. 1A and 1B, taken in the circle B;

FIG. 2A is a plan view of a second embodiment of aspects of the invention;

FIG. 2B is a cross-sectional view of the embodiment of FIG. 2A, taken through the line A-A;

FIG. 2C is a detail view of the embodiment of FIGS. 2A and 2B, taken in the circle B;

FIG. 3 is a is a perspective view of a third embodiment of aspects of the invention;

FIG. 4A is a perspective view of a fourth embodiment of aspects of the invention;

FIG. 4B is a cross-sectional view of the embodiment of FIG. 4A, taken through the line A-A;

FIG. 5A is a plan view of a fifth embodiment of aspects of the invention;

FIG. 5B is a cross-sectional view of the embodiment of FIG. 5A, taken through the line A-A;

FIG. 6 is a cross-sectional view of a sixth embodiment of aspects of the invention;

FIG. 7 is a cross-sectional view of a seventh embodiment of aspects of the invention;

FIG. 8 is a cross-sectional view of a eighth embodiment of aspects of the invention; and

FIG. 9 is a plan view of a ninth embodiment of aspects of the invention incorporating elements of the embodiments of FIGS. 1A, 1B and 1C with an embodiment of a retention feature.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Embodiments of aspects of the present invention are formed of shaped transparent or translucent substrates to which coatings or other surface treatments have been applied so as to direct, reflect or shield light in a desired pattern. A variety of substrate materials, coating materials and shapes may be used, as explained below.

A high degree of light transmission at the range of wavelengths of interest is desirable. In common, architectural and task lighting applications, it is desirable that the substrate material be transparent over a wide range of the visible light band of wavelengths. Other applications may require transparency at other wavelengths.

The architectural lighting louver according to aspects of embodiments of the invention intended for use in applications placing it in close proximity to a lamp or other light source. Lamps and other light sources also are sources of heat. Therefore, the substrate material should be a heat resistant material, a heat conductive material or a heat dissipative material. Materials with combinations of these properties can also be used. Materials which conduct or dissipate heat well are particularly suitable for use in embodiments of aspects of the invention because they provide the beneficial side effect of keeping lamp and luminaire temperatures down.

In order to form the substrate into the complex shapes described below, it is preferable that the substrate materials be either moldable or readily machined or cut. As discussed further below, the substrate is molded, cut or machined into shapes having surfaces that when coated, direct light as desired. The substrate material itself, however, does not primarily direct the light, but merely supports coatings suitable at orientations. Thus, the combination of a transparent, heat resistant, readily-shaped material provides the desired characteristics.

Examples of substrate materials that are suitable include some plastic materials, such as polycarbonates, Plexiglas and Lucite. Some glasses may also be suitable. Other materials having one or more of the characteristics described may also be suitable for some embodiments of aspects of the invention.

Coating materials suitable for embodying some aspects of the invention include various opaque and reflective materials. Opaque materials may include paints, thin film deposited materials, and surface treatments such as texturing, all of which can reduce the light transmission through a surface. Reflective materials may include thin film depositions of metals and other reflective materials. As will be explained below, the coating materials are applied to particular surfaces of the shaped substrate, so as to direct light in a desired direction or manner.

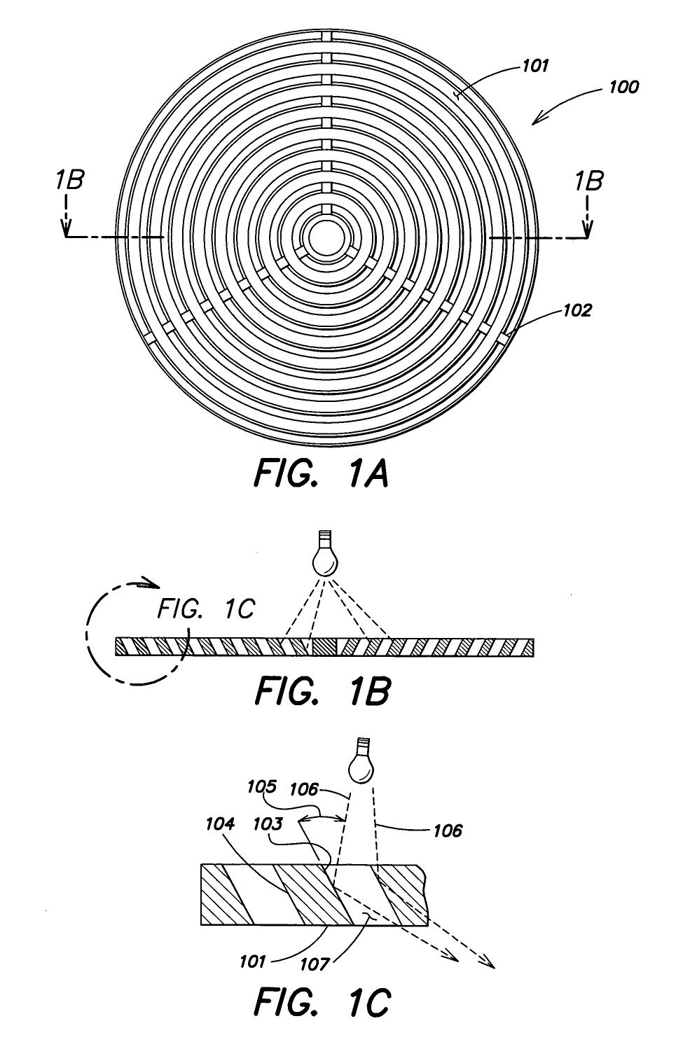

FIG. 1A shows a louver 100 having a generally axial plan. The substrate is formed into a series of concentric rings 101 supported in a circular array by radial supports 102. Each ring 101 has inner 103 and outer 104 surfaces as well as top and bottom surfaces. Each describes inner 103 and outer 104 surfaces of a frustum of a cone. The cross-section of FIG. 1B, as further illustrated in the detail of FIG. 1C shows that the surfaces form an angle 105 with respect to light emitted by a light source placed above or below the louver 100. The inner 103 and outer 104 surfaces of each ring 101 are coated with one of the coatings described above so as to direct light 106 through the substrate forming a ring 101 or through the spaces 107 between the rings 101 in a direction determined by the angle 105 of the surfaces.

The embodiments of FIGS. 1A, 1B and 1C provide even light distribution, and relatively low brightness impinging on the viewer.

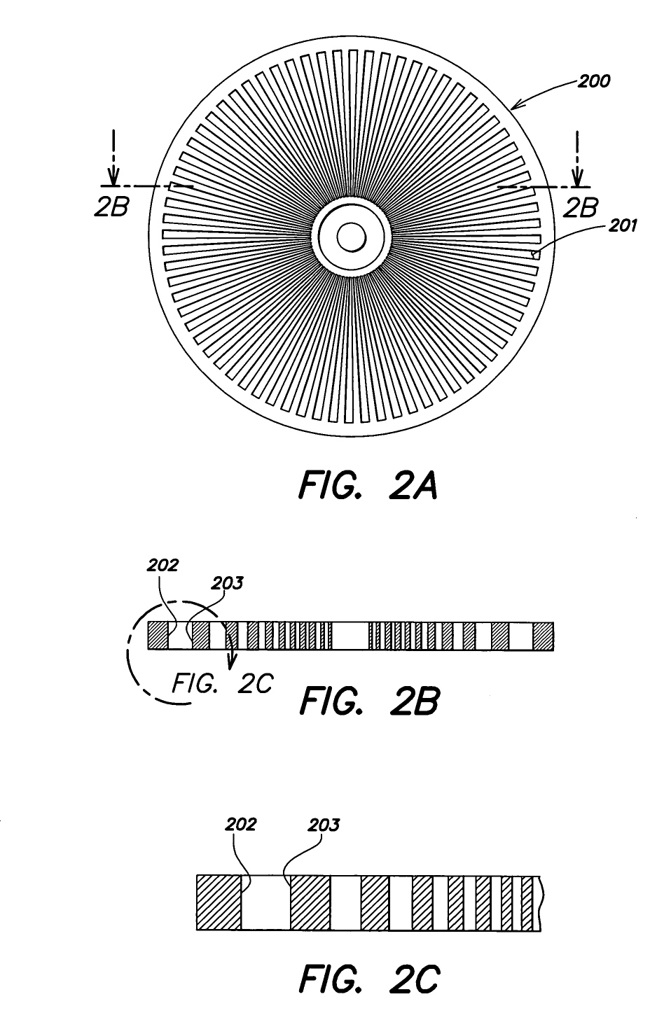

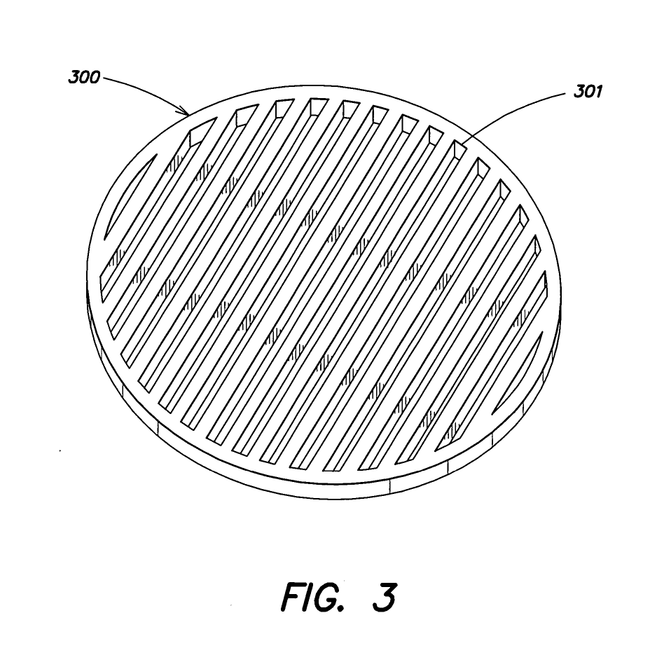

According to another embodiment of aspects of the invention, as shown in FIG. 2A, the substrate 200 may be shaped to form radial slots 201. Each slot 201 is defined between walls 202, 203 of a portion of the substrate. Each of the walls 202, 203 is coated using one of the coatings described above, such that light is directed in a direction defined by the walls, either through the substrate or through the slot.

The embodiments of FIGS. 2A, 2B and 2C provide good wide-angle light dispersion.

As shown in FIG. 3, a variation is possible in which a series of parallel slots is formed through the substrate 300. As in the previous embodiments, each slot 301 is defined by walls of the substrate material which have been coated with a material as described above. Light is thereby directed through the slots and the substrate material in a direction defined by the walls of the slot.

The embodiment of FIG. 3 elongates the beam along the direction of the slots 301 and correspondingly narrows the beam along the direction across the slots 301.

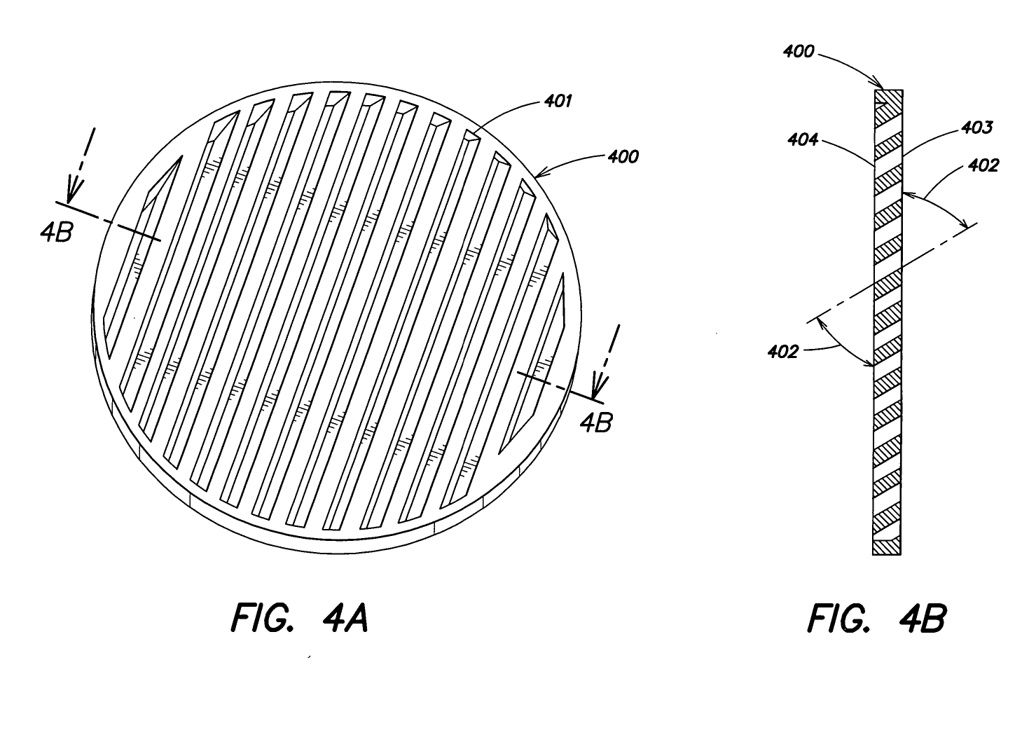

The embodiment of aspects of the invention shown in FIG. 3 can be varied as shown in FIGS. 4A and 4B, in which the slots 401 are angled 402 with respect to upper 403 and lower 404 surfaces of the substrate material 400.

The embodiments of FIGS. 4A and 4B also elongate the beam along the direction of the slots and correspondingly narrow the beam along the direction across the slots, as with the embodiment of FIG. 3. By angling the slots, as done in the embodiments of FIGS. 4A and 4B, these constructions are useful for wall wash applications, where an even distribution of light along a large surface is desired.

The embodiment of aspects of the invention described thus far may be formed by cutting, machining or molding. Any other process suitable for forming the slots completely through the substrate may be used. The process may be any suitable for forming straight-sided slots completely through the substrate.

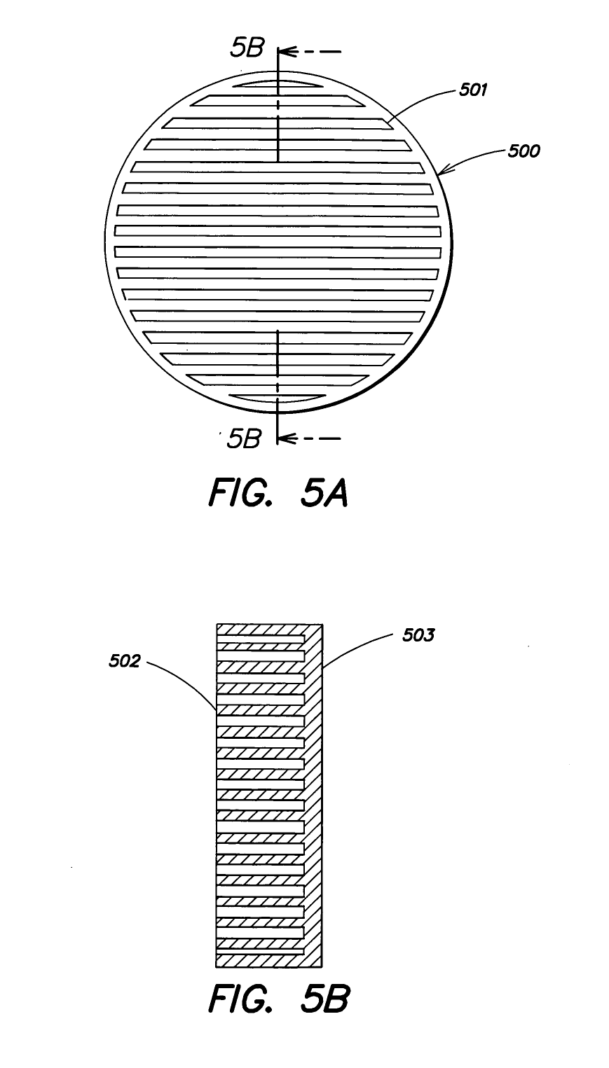

As shown in FIGS. 5A and 5B, there may also be embodiments of aspects of the invention in which one or more of the slots 501 do not pass completely through the substrate 500 from a top surface 502 to a bottom surface 503. Embodiments of aspects of the invention in which the slots pass completely through the substrate may be advantageous in applications where ventilation and heat dissipation are substantial considerations, while embodiments of the invention having at least one closed surface may be advantageous where protection of the lamp or luminaire from the environment or vice versa are important.

The embodiments of FIGS. 5A and 5B are useful in automotive applications and other outdoor applications, as well as applications requiring an environmental seal. The slot directions of the embodiments of FIGS. 5A and 5B can be varied according to any of the forgoing embodiments, while including a closed surface.

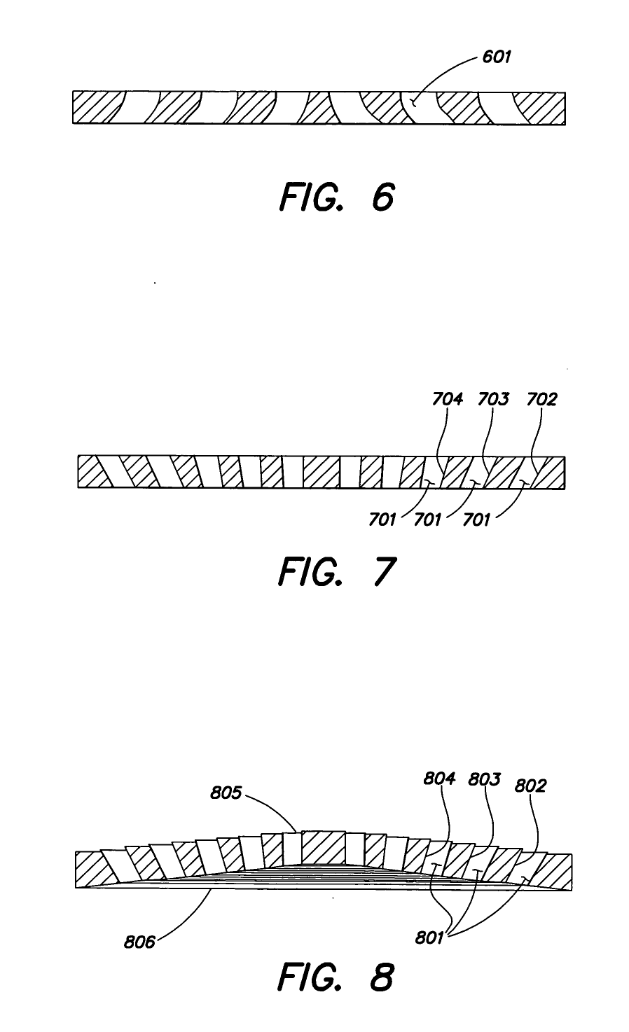

As shown in the embodiments of FIG. 6, 7 and 8, more complex profiles of the slots may be formed using suitable manufacturing techniques with suitable substrate materials. For example, FIG. 6 shows a parabolic slot shape 601, FIG. 7 shows a series of slots 701 having walls 702, 703, 704 with varied angles, and FIG. 8 shows a combination of slots 801 having varied wall 802, 803, 804 angles, together with top 805 and bottom 806 surfaces which are not flat.

The embodiment of FIG. 6 can produce a wide angle of light distribution. The embodiment of FIG. 7, by virtue of the variable slot angles, can focus or concentrate the light pattern to form a “hot spot” where desired. The embodiment of FIG. 8, like that of FIG. 7 can focus or concentrate the light, but is particularly useful with a luminaire having a rear mount reflector, but improving the perpendicularity of the beam to the louver.

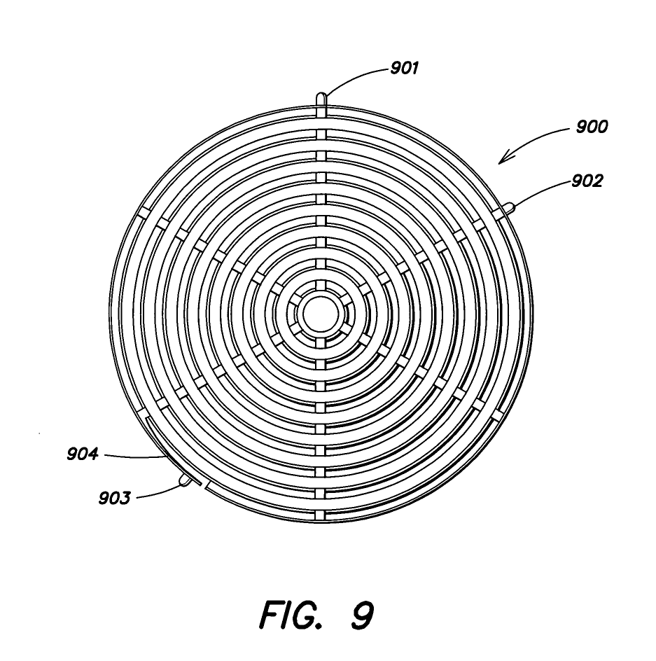

Finally, as shown in FIG. 9, the louver according to embodiments of aspects of the invention may include detent features or pins to retain the louver in a suitably equipped luminaire. The louver according to this embodiment of aspects of the invention includes fixed pins 901, 902 which engage mating holes or slots in the luminaire. The embodiment further includes a pin 903 suspended on a flexible member 904 that may be flexed away from the luminaire for emplacement or removal and which then engages a hole or slot in the luminaire by spring force applied by the flexible member.

Features from each of the foregoing embodiments may be combined with features from other ones of the foregoing embodiments to form more complex structures contemplated by the invention. For example, the retention features may be combined with any of the louver configurations shown. Closed slot designs may be combined with open slot designs to provide suitable protection in some areas while providing required ventilation in others. Numerous other combinations will be apparent to the skilled artisan after considering the foregoing descriptions.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A lighting system component, comprising:
a transmissive substrate having a top and bottom surface and at least one elongate passage defined between the top and bottom surfaces by walls joining the top and bottom surfaces; and
a coating on the walls substantially preventing light transmission through the walls;
whereby light is transmitted through the lighting system component both through the substrate and through the elongate passage substantially without passing through the walls defining the elongate passage.

2. The component of claim 1, wherein the coating is opaque.

3. The component of claim 1, wherein the coating is reflective.

4. The component of claim 1, wherein plural elongate passages form a radial pattern relative to a point on one of the top and bottom surfaces.

5. The component of claim 1, wherein plural elongate passages form a concentric pattern relative to a point on one of the top and bottom surfaces.

6. The component of claim 5, wherein the walls are angled parallel to a desired directed of light transmission.

7. The component of claim 6, wherein at least one of the walls defined at least part of a frustum of a cone.
